(19) United States
(12) Patent Application Publication
(10) Pub. No.: US 2012/0223541 A1
(43) Pub. Date: Sep. 6, 2012

(54) TAILGATE GAP COVER

(76) Inventor: Peter Gianino, Shelby Township, MI (US)

(21) Appl. No.: 13/037,656

(22) Filed: Mar. 1, 2011

(51) Int. Cl. B62D 33/03; E06B 7/28

(52) U.S. Cl. 296/57.1; 49/383

(57) ABSTRACT

A tailgate gap cover releasably engages a vehicle body having a gap disposed between a back end and tailgate of the vehicle body. The tailgate gap cover includes a plate that extends between a plate leading edge and a plate trailing edge and a flap that extends between a flap leading edge and a flap trailing edge. The flap leading edge is pivotally connected to the plate trailing edge to allow rotation of the flap relative to the plate between an open substantially parallel position and a closed substantially perpendicular position. A fastener releasably secures the plate to the vehicle body. The fastener includes a base that is secured to the plate and a latch plate that is secured to the vehicle body and is moveable between a locked position for securing the tailgate gap cover to the vehicle body and an unlocked position for removing the tailgate gap cover.

### BACKGROUND OF THE INVENTION

1. Field of the Invention

The present invention relates to a tailgate gap cover for a gap disposed between the back end of a vehicle body and a tailgate moveable between an open substantially parallel position and a closed substantially perpendicular position.

2. Description of the Prior Art

In past years, pickup trucks have had the majority of vehicle tailgates which swing from a raised, upright position to a lowered, horizontal position for ease and convenience in loading and unloading equipment or supplies to and from the truck bed. In recent years more and more vehicles such as station wagons, vans, four wheel drive vehicles and others are equipped with swingable tailgates to increase their convenience and functionality. Generally, all swingable tailgates create a gap between the end of the truck bed and the tailgate as the tailgate is lowered. This can cause difficulty and may provide an obstacle when loading or unloading heavy articles. Oftentimes, wheels of carts which are used during loading become lodged within the gap and extra effort must be extended to dislodge the wheels. Also, when dirt and other particulate matter is carried on truck beds, loose particles oftentimes fall into the gap created for the tailgate hinge, causing the tailgate movement to jam. Loose material collects in the gap during loading or unloading when the tailgate is open. The material collected in the gap prevents the tailgate from being closed. The material must them be cleaned from the gap before the tailgate can be shut. If the loose material is rock or other rigid material, the shutting of the tailgate can damage the tailgate, bed or associated hinge assemblies.

A variety of tailgate gap covers have been disclosed in prior art patents. An example of one such cover is disclosed in U.S. Pat. No. 4,763,945 to Murray. The Murray patent discloses a tailgate truck mat for preventing loose material from accumulating in the gap between the tailgate and bed end. The mat is a flexible material that is fastened to the tailgate, using a plurality of screws, and slidably engaged to the truck bed with a magnet that allows for the mat to slide on the bed during opening and closing of the tailgate.

Another example of one such cover is disclosed in U.S. Pat. No. 6,540,278 to Presley. The Presley patent discloses a tailgate for a vehicle body that includes a panel member pivotably coupled to the vehicle body. The panel member is slidably supported by the support so that the panel member pivots relative to the vehicle body causing the panel member to slide within the aperture when the tailgate is moved to an open or closed position. The panel member is attached to the vehicle body so as to cover at least a portion of a gap between the vehicle body and the closure member.

### SUMMARY OF THE INVENTION AND ADVANTAGES

The present invention relates to a tailgate gap cover for a vehicle body having a gap disposed between the back end of the vehicle body and a tailgate and where the tailgate is moveable between an open substantially parallel position and a closed substantially perpendicular position. The tailgate gap cover includes a plate that releasably engages the vehicle body and has a first surface that extends between a plate leading edge and a plate trailing edge. The tailgate gap cover further includes a flap having a second surface that extends between a flap leading edge and a flap trailing edge. The flap leading edge is pivotally connected to the plate trailing edge of the plate for rotation of the flap relative to the plate between the open substantially parallel position and the closed substantially perpendicular position. The tailgate gap cover further includes at least one fastener that releasably secures the plate to the vehicle body. The at least one fastener includes a base that is secured to the plate and a latch plate that is secured to the vehicle body or bed liner. The at least one fastener is moveable between a locked position for securing the tailgate gap cover to the vehicle body and an unlocked position for removing the tailgate gap cover.

In a further embodiment, the tailgate gap cover includes a lip portion that extends downwardly from the plate trailing edge to engage the vehicle body or bed liner. The tailgate gap cover is secured to the vehicle body when the base of the at least one fastener is secured to the latch plate to create a first force in a first direction and the lip portion is secured to the vehicle body to create a second force in a second direction that is opposite the first direction to lock the tailgate gap cover into the locked position. The tailgate gap cover is removable when the at least one fastener is in the unlocked position to remove the first force in the first direction to allow for the removal of the tailgate gap cover from the vehicle body.

In a further embodiment, the tailgate gap cover includes a hinge that pivotally connects the flap relative to the plate. The flap and the plate engage each other at the hinge to engage the first and second surfaces to cover the gap in the vehicle body. The hinge biases the flap toward the tailgate in both the open substantially parallel position and the closed substantially perpendicular position to maintain contact between the flap trailing edge and the tailgate. As a result, the flap trailing edge maintains contact and slideably engages the tailgate between the open substantially parallel position and the closed substantially perpendicular position.

The subject invention provides for a tailgate gap cover that prevents the egress of debris and material into the gap between the vehicle body and the pivotable tailgate. Further, the tailgate gap cover of the subject invention provides for an easy and cost effective installation and removal of the tailgate gap cover. The subject invention further provides for a tailgate gap cover that crates a span over a gap for the movement of wheels over the gap.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a vehicle body embodying a tailgate gap cover according to the subject invention;

FIG. 2 is a partial perspective view of a vehicle body embodying the tailgate gap cover and fastener of the subject invention;

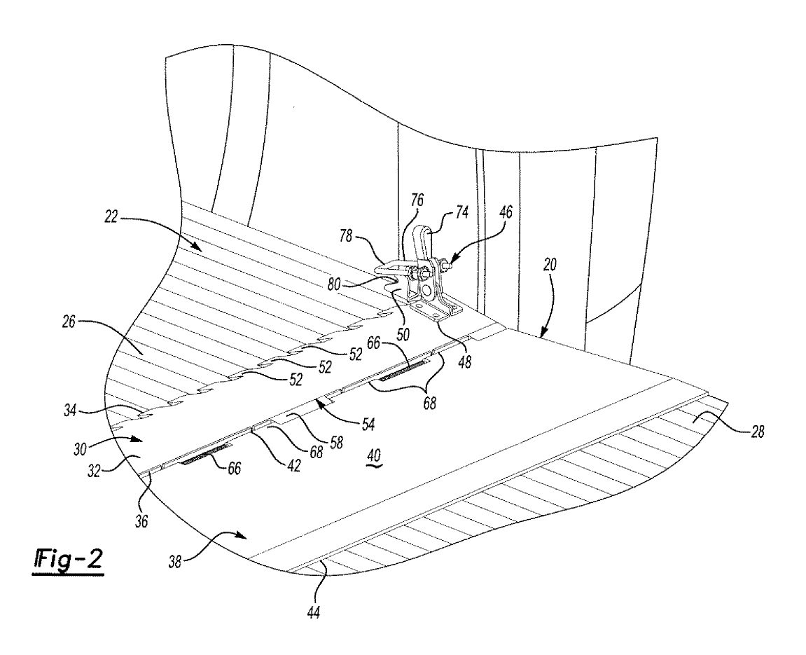

FIG. 3 is a perspective view of a tailgate gap cover according to the subject invention;

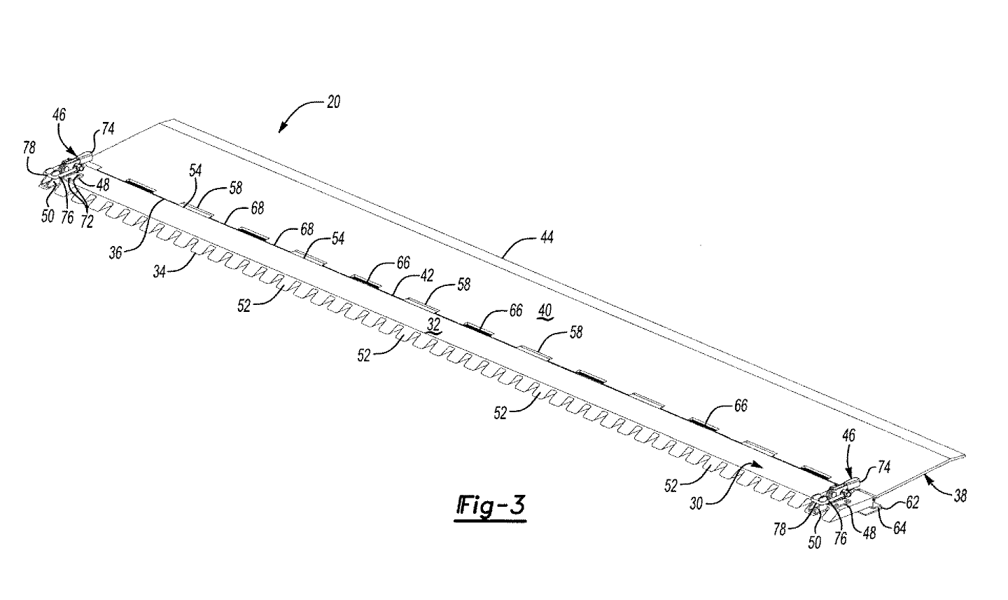

FIG. 4 is a partial perspective view of a tailgate gap cover and fastener according to the subject invention;

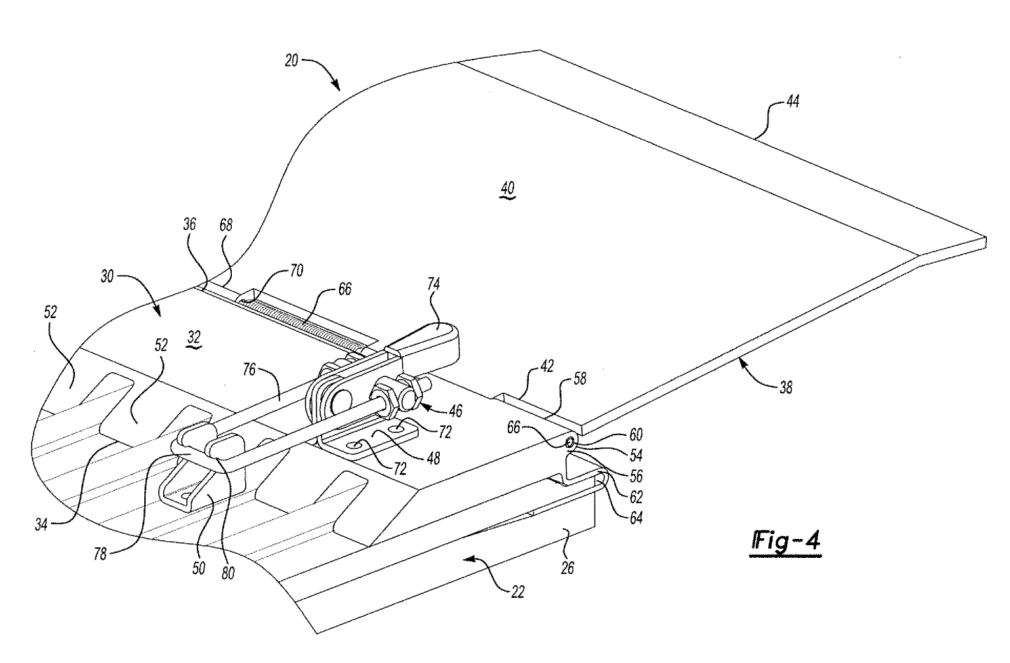

FIG. 5 is a side view of the tailgate gap cover according to the subject invention showing the tailgate in a closed substantially perpendicular position; and

FIG. 6 is a side view of the tailgate gap cover according to the subject invention showing the tailgate in an open substantially parallel position.

### DETAILED DESCRIPTION OF THE INVENTION

Referring to the Figures, wherein like numerals indicate corresponding parts throughout the several views, a tailgate gap cover 20 is generally shown for a vehicle body 22 having a gap 24 disposed between the back end 26 of the vehicle body 22 and a tailgate 28 moveable between an open substantially parallel position and a closed substantially perpendicular position.

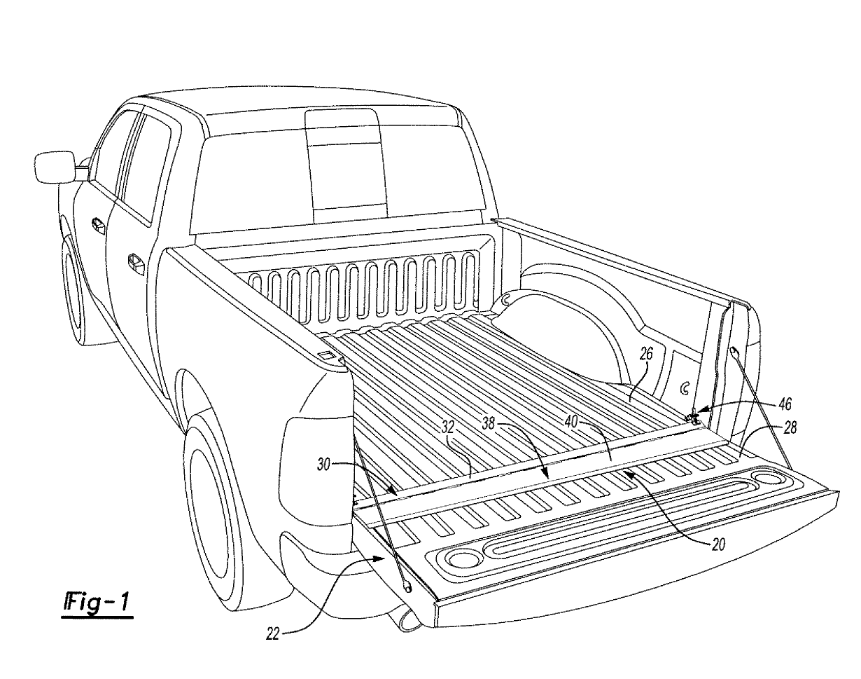

It is noted, while the particular vehicle illustrated is a pick-up truck, as shown in FIG. 1, it will be understood that the teachings of the present invention have applicability to other types of vehicles, including but not limited to sport utility vehicles, minivans, station wagons or any other vehicle having a pivotable tailgate arrangement. In addition, while in exemplary embodiment the vehicle body 22 includes a bed liner, it should be understood that the subject invention could be incorporated for use without a bed liner.

The present invention relates to a tailgate gap cover 20 for a vehicle body 22 having a gap 24 disposed between the back end 26 and tailgate 28 of the vehicle body 22. The tailgate gap cover 20 includes a plate 30 that releasably engages the vehicle body 22 and has a first surface 32 that extends between a plate leading edge 34 and a plate trailing edge 36. The tailgate gap cover 20 further includes a flap 38 having a second surface 40 that extends between a flap leading edge 42 and a flap trailing edge 44. The flap leading edge 42 is pivotally connected to the plate trailing edge 36 of the plate 30 to allow for rotation of the flap 38 relative to the plate 30 between the open substantially parallel position and the closed substantially perpendicular position. At least one fastener 46 secures the plate 30 to the vehicle body 22. The at least one fastener 46 is moveable between a locked position for securing the tailgate gap cover 20 to the vehicle body 22 and an unlocked position for removing the tailgate gap cover 20. In the exemplary embodiment, the at least one fastener 46 includes a base 48 secured to one of the plate 30 and the vehicle body 22 and a latch plate 50 secured to the other of the plate 30 and vehicle body 22 that releasably engage one another to secure the plate 30 to the vehicle body 22. Any suitable fastener 46 known in the art and capable of movement between a locked position for securing the tailgate gap cover 20 to the vehicle body 22 and an unlocked position for removing the tailgate gap cover 20 may be used.

The tailgate gap cover 20 according to the subject invention includes a plate 30 of high density polyethylene for releasably engaging the vehicle body 22. While the exemplary embodiment is made of high density polyethylene, any suitable, rigid, durable material known in art may be used, including, but not limited to stainless steel and aluminum. The plate 30 includes a plate leading edge 34 that engages the back end 26 of the vehicle body 22 and a plate trailing edge 36 spaced parallel from the plate leading edge 34. A first surface 32 that is generally flat extends between the plate leading edge 34 and the plate trailing edge 36. The first surface 32 allows for the movement of equipment having at least one wheel over the gap 24.

While the plate 30 may be a flat plate 30 that engages the vehicle body 22, the exemplary embodiment includes a plurality of spaced leg portions 52. The leg portions 52 are used with vehicle bodies 22 that are not flat and have a plurality of ribs that extend upwardly from the vehicle body 22 or bed liner. The leg portions 52 are disposed in the portions between adjacent ribs to limiting the ingress of material and debris between the ribs. The leg portions 52 extend downwardly from the first surface 32 and at an angle to the plate leading edge 34, and correspond to the vehicle body 22 to limit the ingress of materials into the gap 24 through the adjacent ribs. In the exemplary embodiment, the leg portions 52 are molded or cut into the plate 30. In an alternative embodiment, the leg portions 52 may be a flexible material that is secured to the plate 30 and capable of conforming to the vehicle body 22.

A pivot portion 54 is disposed at the plate trailing edge 36. The pivot portion 54 may be a separate and distinct structure from the plate 30, or it may be incorporated or manufactured into the plate 30. The pivot portion 54 includes a body portion 56 and a plurality of first knuckle portions 58 that are spaced horizontally and extend outwardly from the body portion 56. Each of the first knuckle portions 58 define a circular first opening 60 that extends horizontally through the first knuckle portion 58. A lip portion 62 extends downwardly from the body portion 56 to engage the back end 26 of the vehicle body 22. The lip portion 62 is shaped to define an engagement notch 64 to engage the back end 26 of the vehicle body 22. In the preferred embodiment, the lip engages the vehicle body 22 by sliding the engagement notch 64 around the edge of the bed liner.

The tailgate gap cover 20 includes a hinge 66 that extends horizontally through each of the first openings 60 of the first knuckle portions 58. While any hinge 66 known in the art may be used, the exemplary embodiment uses a stainless steel spring loaded hinge 66. The hinge 66 will be described in greater detail below.

The tailgate gap cover 20 according to the subject invention includes a flap 38 of high density polyethylene that is pivotally connected to the pivot portion 54 of the plate 30. While the exemplary embodiment is made of high density polyethylene, any suitable, rigid, durable material known in art may be used, including, but not limited to stainless steel and aluminum. The flap 38 includes a second surface 40 that extends between a flap leading edge 42 and a flap trailing edge 44. The flap leading edge 42 is pivotally connected to the pivot portion 54 of the plate 30 and the flap trailing edge 44 extends outwardly from the flap leading edge 42 to span the gap 24 and engage the tailgate 28. The flap 38 is generally flat, but may include an angled portion at the flap trailing edge 44 that engages the tailgate 28. The second surface 40 allows for the movement of equipment having at least one wheel over the gap 24. The flap 38 includes a plurality of second knuckle portions 68 that are spaced horizontally and extend outwardly from the flap leading edge 42. The second knuckle portions 68 are spaced to correspond with the spaced portions between the first knuckle portions 58 such that second knuckle portions 68 are disposed in the spaced portions between adjacent first knuckle portions 58. Each of the second knuckle portions 68 define a circular second opening 70 that extends horizontally through the second knuckle portion 68 to receiving the hinge 66. The flap 38, through the second knuckle portions 68, is pivotally connected to the pivot portion 54 of the plate 30 by the hinge 66. The assembly allows for rotation of the flap 38 relative to the plate 30 between the open substantially parallel position and the closed substantially perpendicular position.

According to the subject invention, the flap 38 and the plate 30 engage each other at the hinge 66 to engage the first and second surfaces 32, 40 for covering the gap 24 in the vehicle body 22. The hinge 66 biases the flap 38 toward the tailgate 28 in both the open substantially parallel position and the closed substantially perpendicular position. The biasing of the flap 38 maintains contact between the flap trailing edge 44 and the tailgate 28 such that the flap trailing edge 44 slideably engages the tailgate 28 between the open substantially parallel position and the closed substantially perpendicular position. One skilled in the art will understand that in pivoting the flap 38 from the open substantially parallel position to the closed substantially perpendicular position will cause the flap trailing edge 44 to translate forward relative to the tailgate 28 and along the tailgate 28 as the tailgate 28 rotates.

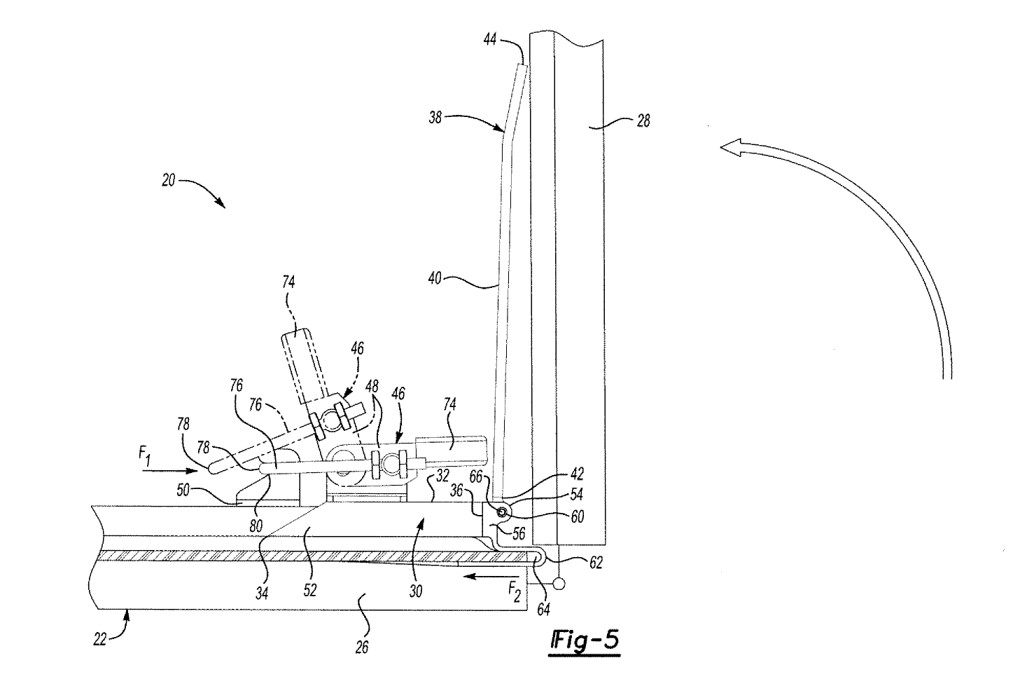

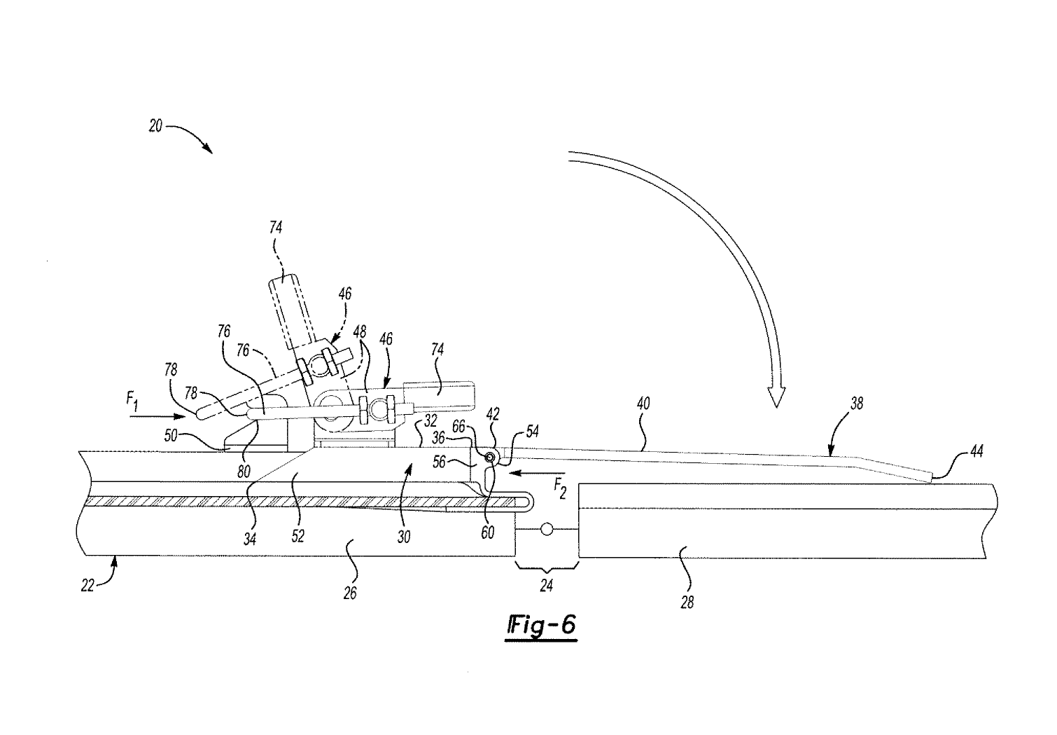

The tailgate gap cover 20 includes at least one fastener 46 that releasably secures the plate 30 to the vehicle body 22. In the preferred embodiment, a plurality of fasteners 46 are used. The at least one fastener 46 includes a base 48 secured to the plate 30 and a latch plate 50 that is secured to the vehicle body 22. The latch plate 50 may secured to the vehicle body 22 or bed liner by any means known in the art. The at least one fastener 46 is moveable between a locked position for securing the tailgate gap cover 20 to the vehicle body 22 and an unlocked position for removing the tailgate gap cover 20. The base 48 defines a plurality of base openings 72 to secure the base 48 portion to the plate 30. In the exemplary embodiment a fastening mechanism, such as a screw, is used to secure the base 48 to the plate 30, but the base 48 may be secured to the plate 30 by any fastening mechanism known in the art. As shown best in FIGS. 5 and 6, the fastener 46 further includes a handle 74 that is pivotally connected to the base 48 to move the fastener 46 between the locked position (shown in solid) and the unlocked position (shown in phantom). The latch bracket 76 is secured to the handle 74 and includes an engagement portion 78 that engages the latch plate 50 in the locked position. According to the subject invention, the latch plate 50 engages the vehicle body 22 and defines a securing notch 80. The securing notch 80 of the latch plate 50 receives the engagement portion 78 of the latch bracket 76 to create a first force F₁ in the first direction when the fastener 46 is in the locked position to secure the tailgate gap cover 20 to the vehicle body 22.

As shown in FIGS. 5 and 6, the tailgate gap cover 20 is secured to the vehicle body 22 when the base 48 of the at least one fastener 46 is secured to the latch plate 50 to create the first force F₁ in a first direction and the lip portion 62 of the plate 30 is secured to or engages the vehicle body 22 to create a second force F₂ in a second direction opposite the first direction to lock the tailgate gap cover 20 into the locked position. The opposite first and second forces F₁, F₂ act to lock the tailgate gap cover 20 to the vehicle body 22. The tailgate gap cover 20 is removable when the at least one fastener 46 is in the unlocked position (shown in phantom in FIGS. 5 and 6) to remove the first force F₁ in the first direction and to allow for the removal of the tailgate gap cover 20 from the vehicle body 22.

The present invention provides for a tailgate gap cover 20 that is easily and quickly installed and removed readily at any time.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

What is claimed is:

1. A tailgate gap cover for a vehicle body having a gap disposed between the back end of the vehicle body and a tailgate moveable between an open substantially parallel position and a closed substantially perpendicular position comprising:
a plate for releasably engaging the vehicle body and having a first surface extending between a plate leading edge and a plate trailing edge;
a flap having a second surface extending between a flap leading edge and a flap trailing edge, said flap leading edge being pivotally connected to said plate trailing edge of said plate for rotation of said flap relative to said plate between the open substantially parallel position and the closed substantially perpendicular position; and
at least one fastener for releasably securing said plate to the vehicle body, said at least one fastener having a base secured to said plate and a latch plate capable of being secured to the vehicle body, said at least one fastener being moveable between a locked position for securing the tailgate gap cover to the vehicle body and an unlocked position for removing the tailgate gap cover.

2. The tailgate gap cover as set forth in claim 1 further including a lip portion extending downwardly from said plate trailing edge for engaging the vehicle body.

3. The tailgate gap cover as set forth in claim 2 wherein the tailgate gap cover is secured to the vehicle body when said base of said at least one fastener is secured to said latch plate to create a first force in a first direction and said lip portion is secured to the vehicle body to create a second force in a second direction opposite said first direction to lock the tailgate gap cover into the locked position and the tailgate gap cover is removable when said at least one fastener is in the unlocked position to remove the first force in the first direction and allow for the removal of the tailgate gap cover from the vehicle body.

4. The tailgate gap cover as set forth in claim 2 wherein said lip portion is shaped to define an engagement notch for engaging the back end of the vehicle body.

5. The tailgate gap cover as set forth in claim 1 further including a hinge to pivotally connect said flap relative to said plate, and wherein said flap and said plate engage each other at said hinge to engage the first and second surfaces for covering the gap in the vehicle body, and said hinge biases said flap toward the tailgate in both the open substantially parallel position and the closed substantially perpendicular position for maintaining contact between said flap trailing edge and the tailgate such that said flap trailing edge slideably engages the tailgate between the open substantially parallel position and the closed substantially perpendicular position.

6. The tailgate gap cover as set forth in claim 1 wherein said hinge is a stainless steel spring loaded hinge.

7. The tailgate gap cover as set forth in claim 1 further including a plurality of first knuckle portions spaced horizontally and extending outwardly from said plate trailing edge, each of said first knuckle portions defining a first opening extending horizontally through said first knuckle portion.

8. The tailgate gap cover as set forth in claim 7 further including a hinge extending horizontally through each of said first openings of said first knuckle portions.

9. The tailgate gap cover as set forth in claim 8 wherein said flap includes a plurality of second knuckle portions spaced horizontally and extending outwardly from said flap leading edge to correspond with the spaced portions between said first knuckle portions, each of said second knuckle portions defining a second opening extending horizontally through said second knuckle portion for receiving said hinge.

10. The tailgate gap cover as set forth in claim 1 wherein said plate includes a pivot portion at said plate trailing edge, said pivot portion having a body portion and a plurality of first knuckle portions spaced horizontally and extending outwardly from said body portion, each of said first knuckle portions defining a first opening extending horizontally through said first knuckle portion.

11. The tailgate gap cover as set forth in claim 1 further including a plurality of spaced leg portions extending downwardly from said first surface and at an angle to said plate leading edge to correspond to the vehicle body for limiting the egress of materials into the gap.

12. The tailgate gap cover as set forth in claim 1 wherein said at least one fastener includes a plurality of fasteners for releasably securing said plate to the vehicle body.

13. The tailgate gap cover as set forth in claim 1 wherein said at least one fastener includes a handle pivotally connected to said base for moving said at least one fastener between the locked position and the unlocked position and a latch bracket being secured to said handle and having an engagement portion for engaging said latch plate in the locked position.

14. The tailgate gap cover as set forth in claim 13 wherein said latch plate engages the vehicle body and defines a securing notch for receiving said engagement portion of said latch bracket to create a first force in the first direction when at least one fastener is in the locked position to secure said tailgate gap cover to the vehicle body.

15. The tailgate gap cover as set forth in claim 1 wherein said plate and said flap are high density polyethylene.

16. A tailgate gap cover for movement between an open substantially parallel position and a closed substantially perpendicular position comprising:
a vehicle body having a back end and a tailgate pivotally connected to and spaced from said back end to define a gap disposed between said back end and said tailgate;
a plate for releasably engaging said vehicle body and having a first surface extending between a plate leading edge and a plate trailing edge;
a flap having a second surface extending between a flap leading edge and a flap trailing edge, said flap leading edge being pivotally connected to said plate trailing edge of said plate for rotation of said flap relative to said plate between the open substantially parallel position and the closed substantially perpendicular position; and
at least one fastener for releasably securing said plate to said vehicle body, said at least one fastener having a base secured to one of said plate and said vehicle body and a latch plate secured to the other of said plate and said vehicle body, said at least one fastener being moveable between a locked position for securing the tailgate gap cover to said vehicle body and an unlocked position for removing the tailgate gap cover.

17. The tailgate gap cover as set forth in claim 16 further including a lip portion extending downwardly from said plate trailing edge for engaging said vehicle body, and wherein the tailgate gap cover is secured to said vehicle body when said base of said at least one fastener is secured to said latch plate to create a first force in a first direction and said lip portion is secured to said vehicle body to create a second force in a second direction opposite said first direction to lock the tailgate gap cover into the locked position and the tailgate gap cover is removable when said at least one fastener is in the unlocked position to remove the first force in the first direction and allow for the removal of the tailgate gap cover from said vehicle body.

18. The tailgate gap cover as set forth in claim 16 further including a hinge to pivotally connect said flap relative to said plate, and wherein said flap and said plate engage each other at said hinge to engage the first and second surfaces for covering said gap in said vehicle body, and said hinge biases said flap toward said tailgate in both the open substantially parallel position and the closed substantially perpendicular position for maintaining contact between said flap trailing edge and said tailgate such that said flap trailing edge slideably engages said tailgate between the open substantially parallel position and the closed substantially perpendicular position.

19. The tailgate gap cover as set forth in claim 16 wherein said at least one fastener includes a plurality of fasteners for releasably securing said plate to said vehicle body.

20. A tailgate gap cover for a vehicle body having a gap disposed between the back end of the vehicle body and a tailgate moveable between an open substantially parallel position and a closed substantially perpendicular position comprising:
a plate of high density polyethylene for releasably engaging the vehicle body and having a plate leading edge for engaging the back end of the vehicle body and a plate trailing edge spaced parallel from said plate leading edge;
said plate having a first surface being generally flat and extending between said plate leading edge and said plate trailing edge;
a plurality of spaced leg portions extending downwardly from said first surface and at an angle to said plate leading edge to correspond to the vehicle body for limiting the egress of materials into the gap;
a pivot portion at said plate trailing edge and having a body portion, a plurality of first knuckle portions spaced horizontally and extending outwardly from said body portion, each of said first knuckle portions defining a circular first opening extending horizontally through said first knuckle portion, and a lip portion extending downwardly from said body portion for engaging the back end of the vehicle body, said lip portion being shaped to define an engagement notch for engaging the back end of the vehicle body;
a stainless steel spring loaded hinge extending horizontally through each of said first openings of said first knuckle portions;
a flap of high density polyethylene having a second surface being generally flat and extending between a flap leading edge and a flap trailing edge, said flap including a plurality of second knuckle portions spaced horizontally and extending outwardly from said flap leading edge to correspond with the spaced portions between said first knuckle portions, each of said second knuckle portions defining a circular second opening extending horizontally through said second knuckle portion for receiving said hinge and being pivotally connected to said pivot portion by said hinge for rotation of said flap relative to said plate between the open substantially parallel position and the closed substantially perpendicular position;
wherein said flap and said plate engage each other at said hinge to engage the first and second surfaces for covering the gap in the vehicle body, and said hinge biasing said flap toward the tailgate in both the open substantially parallel position and the closed substantially perpendicular position for maintaining contact between the flap trailing edge and the tailgate such that said flap trailing edge slideably engages the tailgate between the open substantially parallel position and the closed substantially perpendicular position;
at least one fastener for releasably securing said plate to the vehicle body, said at least one fastener having a base secured to said plate and a latch plate capable of being secured to the vehicle body, said at least one fastener being moveable between a locked position for securing the tailgate gap cover to the vehicle body and an unlocked position for removing the tailgate gap cover;
wherein the tailgate gap cover is secured to the vehicle body when said base of said at least one fastener is secured to said latch plate to create a first force in a first direction and said lip portion is secured to the vehicle body to create a second force in a second direction opposite said first direction to lock the tailgate gap cover into the locked position and the tailgate gap cover is removable when said at least one fastener is in the unlocked position to remove the first force in the first direction and allow for the removal of the tailgate gap cover from the vehicle body;
said base defining a plurality of base openings for securing said base portion to said plate;
a handle pivotally connected to said base for moving said at least one fastener between the locked position and the unlocked position;
a latch bracket being secured to said handle and having an engagement portion for engaging said latch plate in the locked position;
wherein said latch plate engages the vehicle body and defines a securing notch for engaging said engagement portion of said latch bracket to create the first force in the first direction when at least one fastener is in the locked position to secure said tailgate gap cover to the vehicle body.
